(19) United States
(12) Patent Application Publication
(10) Pub. No.: US 2013/0311181 A1
(43) Pub. Date: Nov. 21, 2013

(54) SYSTEMS AND METHODS FOR IDENTIFYING CONCEPTS AND KEYWORDS FROM SPOKEN WORDS IN TEXT, AUDIO, AND VIDEO CONTENT

(71) Applicants: Walter Bachtiger, Novato, CA (US); Jan Jannink, Menlo Park, CA (US); Jay Blazensky, Palo Alto, CA (US)

(72) Inventors: Walter Bachtiger, Novato, CA (US); Jan Jannink, Menlo Park, CA (US); Jay Blazensky, Palo Alto, CA (US)

(21) Appl. No.: 13/953,635

(22) Filed: Jul. 29, 2013

Related U.S. Application Data
(63) Continuation-in-part of application No. 13/271,195, filed on Oct. 11, 2011.
Application No. 13/271,195 is a continuation-in-part of application No. 12/878,014, filed on Sep. 8, 2010, now abandoned.
(60) Provisional application No. 61/676,967, filed on Jul. 29, 2012.
(60) Provisional application No. 61/244,096, filed on Sep. 21, 2009.

(51) Int. Cl. G10L 15/26

(52) U.S. Cl. CPC G10L 15/26
USPC 704/235

(57) ABSTRACT

Systems for identifying, summarizing, and communicating topics and keywords included within an input file are disclosed. The systems include a server that receives one or more input files from an external source; conducts a speech-to-text transcription (when the input file is an audio or video file); and applies an algorithm to the text in order to analyze the content therein. The algorithm calculates a total score for each word included within the text, which is calculated using a variety of metrics that include: a length of each word in relation to a mean length of words, the frequency of letter groups used within each word, the frequency of repetition of each word and word sequences, a part of speech that is represented by each word, and membership of each word within a custom set of words. The systems are further capable of generating a graphical representation of each input file, which depicts those parts of the input file that exhibit a higher total score from those that do not. In addition, the systems allow users to publish commentary—through an email interface—to such graphical representations of the input files.

### CROSS-REFERENCE TO RELATED APPLICATIONS

This application is a non-provisional of, and claims priority to, U.S. provisional patent application Ser. No. 61/676,967, filed on Jul. 29, 2012, and is also a continuation-in-part of U.S. patent application Ser. No. 13/271,195, filed on Oct. 11, 2011, which is a continuation-in-part of U.S. patent application Ser. No. 12/878,014, filed on Sep. 8, 2010, which claims priority to U.S. provisional patent application Ser. No. 61/244,096, filed on Sep. 21, 2009.

### FIELD OF THE INVENTION

The field of the present invention relates to systems and methods for analyzing words included within text, audio, and video content and, particularly, to extracting, summarizing, and communicating important themes, concepts, topics, and keywords found within such content.

### BACKGROUND OF THE INVENTION

There are currently a variety of systems available that can be used to extract information from text, audio content, and video content. For example, various types of software programs have been developed over the years, which enable users to transcribe spoken words into text, such that the transcribed text may then be reviewed and/or archived. While these existing systems and software programs offer some level of utility (for certain rudimentary tasks), these currently-existing systems fall well short of providing information to a user that extends beyond the mere transcribed word. Indeed, these systems are not able to extract and accurately convey important themes, concepts, topics, and keywords that are found within such content. Accordingly, there is a growing demand for improved methods and systems that can not only transcribe audio or video content into text, but can also extract and communicate the important themes, concepts, topics, and keywords found within such content.

### SUMMARY OF THE INVENTION

According to certain aspects of the present invention, systems and methods for analyzing words included within text, audio, and video content are provided, which are configured to identify, extract, summarize, and communicate important themes, concepts, topics, and keywords found within such content. More particularly, the systems include a server that is configured to: (a) receive input files containing content from an external source; (b) process the files using speech-to-text transcription when the content format is video or audio; and (c) apply an algorithm to the text in order to analyze the content. The invention provides that the algorithm calculates a total score for each word included within the text (and then, as explained further below, generates an aggregated map of the total scores for all words included within the input file). The total score for each word is calculated using a variety of metrics that include: (i) a length of each word in relation to a mean length of words, (ii) frequency of letter groups used within the words, (iii) frequency of repetition of the words and word sequences in the text, (iv) a part of speech analysis of words in the text, and (v) membership of words within a custom and pre-defined set of words. The scores may be further adjusted by incorporating metadata from the input files, such as intensity or loudness metrics, confidence level in transcription, clarity of each word, speed of speech, and/or location within a speech.

According to additional aspects of the present invention, the systems are further capable of generating a graphical representation of each input file, which depicts those parts of the input file that exhibit a higher total score from those that exhibit a relatively lower total score. As such, the graphical representation will be effective to quickly convey the more relevant (and content-rich) portions of an input file, from those that are less relevant (and less central to the primary topic of the input file). Still further, the invention provides that a list of the top concepts or keywords from the file may be displayed, along with the above-mentioned graphical representation of the file. The invention provides that user selection of any of the keywords in the list will cause the display of markers, which show the relative position of the keywords in the graphical representation of the input file, snippets of text surrounding the keywords, and further enabling playback of the content at that position for video and audio files.

According to yet further aspects of the present invention, the systems are configured to issue emails to a defined number of users, which provide access to the graphical representation of a particular input file (and further allow such users to access desired portions of the underlying input file itself). Still further, the invention provides that the systems will enable such users to publish commentary to the graphical representation of a particular input file through an email interface, as described further below. According to such aspects of the invention, a list of the top concepts or keywords from the file will accompany the emails sent to such users. The invention provides that user selection of any of the keywords in such emails will be tabulated to further measure the relevance and popularity of the keywords presented therein.

The above-mentioned and additional features of the present invention are further illustrated in the Detailed Description contained herein.

### BRIEF DESCRIPTION OF THE FIGURES

FIG. 1: is an illustration of the various components of the systems described herein.

FIG. 2: is an illustration that demonstrates the interactive nature, and input file sharing capabilities, of the systems described herein.

FIG. 3: is an illustration of a graphical representation of a timeline, which is correlated to an input file that has been provided to the system described herein and that exhibits a “heat map” aspect that identifies content-rich portions of the input file.

FIG. 4: is an illustration of an example email that may be issued to provide access to an input file that has been analyzed using the systems described herein, and to publish commentary in connection with such analysis.

FIG. 5: is another illustration of the graphical representation of the timeline of FIG. 3, which illustrates how users of the system may generate commentary regarding the contents of the input file and post such commentary to the timeline, using the email interface of FIG. 4.

FIG. 6: is an illustration of another graphical representation of a timeline, which is correlated to an input file that has been provided to the system described herein, which illustrates the means by which the location of selected keywords is portrayed within such timeline.

FIG. 7: is an illustration of another graphical representation of a timeline, which is correlated to an input file that has been provided to the system described herein, which illustrates the means by which the location of multiple keywords is portrayed within such timeline.

FIG. 8: is a diagram that illustrates the system described herein being incorporated into a telecommunications environment.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

The present invention employs a verbal salience approach to identifying themes, concepts, topics, and keywords found within audio content (and audio content embedded within video content), regardless of the number of spoken words that may be included within such audio content (which are subjected to the analysis described herein). More particularly, the present invention employs the use of novel algorithms, along with computing systems that execute such algorithms, which are capable of assigning scores to individual words (and groups of words) included within such audio content. These algorithms are effective to recognize the relative importance of a particular segment of speech, both relative to the portions of the speech that precede such segment and in relation to the entire speech (i.e., the words that precede and follow the particular segment of speech).

Word Scoring Methods

The algorithms that are used in connection with the present invention include multiple components and metrics for analyzing words. Before such algorithms are applied to the words, however, the systems of the present invention will execute a transcription step (when the input file is formatted as audio or video), pursuant to which the system will transcribe audio content into text, as explained in more detail below. After the audio content has been transcribed into text (in the case of input files that are received in video or audio format), the system will apply the algorithms described below.

To begin, the system calculates the length of each word, in relation to a mean length of words. The mean length of words may be calculated from (i) the length of each word (i.e., the number of letters included within each word) that comprises the content being analyzed that precedes a particular word, (ii) the length of each word that comprises all of the content being analyzed, (iii) the length of words calculated from a source outside of the content being analyzed (e.g., an average length of words calculated from the results of an Internet search), or (iv) a combination of (i)-(iii). The invention provides that words that are longer than the relevant mean are assigned a positive score and words that are shorter than the relevant mean are assigned a negative score. The invention provides that a functional relationship F₁ exists between the scores (which is also referred to herein as “(a)”) and the variation from the word length mean “m,” i.e., F₁ (I−(m))=(a).

The algorithms used in the present invention next measure the relative energy of each word included within the content being analyzed. The relative energy of each word is preferably quantified and reduced to a numeric score (also referred to herein as “(b)”). The energy may be analyzed, for example, based on its sonic or lexical complexity. More particularly, this score will preferably be reflective of letter group frequency, i.e., how frequent (or infrequent) a certain letter group may be within each word, in relation to general speech content (whether internal or external to the content being analyzed). The invention provides that the more infrequent a certain letter group is calculated to be, the more likely that particular word carries more relevance than other words. The words that include infrequently used letter groups will be assigned a higher sonic or lexical complexity score “(b)”, whereas words that do not include infrequently used letter groups will be assigned a lower sonic or lexical complexity score.

The invention provides that the algorithms and systems described herein will next calculate the frequency with which each word is used (and/or word sets). Here again, this frequency metric—also referred to herein as “(c)”—may be calculated relative to the frequency of each word (or set of words) within the content being analyzed (and/or relative to the frequency of each word (or set of words) within speech generally, such as the frequency of each word (or set of words) that is calculated from an Internet search). The invention provides that such metric is useful for identifying distinguishing words (and word sets), and informs the system that an infrequently utilized word (and word set) may pertain to a more relevant portion of a speech, discussion, or other content, relative to other portions of such content. According to such embodiments, the frequency of each word (or word set) will be inversely proportional to the frequency value “(c)” assigned to such word, such that infrequently used words (or word sets) are assigned more relevance and higher (c) values than other commonly used words (or word sets).

According to further embodiments, the algorithms and systems used in the present invention will preferably assign a “part of speech score” to each word (referred to herein as “(d)”), namely, a score that indicates whether the word is a verb, noun, adjective, adverb, or other type of speech component. According to such metrics, the part of speech score will be higher for nouns and verbs, and relatively lower for adjectives and adverbs. The invention provides that the part of speech score will inform the system that certain words will likely carry more relevance than others. More particularly, for example, the system may be configured to create a hierarchy of scores based on such criteria, e.g., nouns (2), verbs (1.5), adjectives (1), and adverbs (0.5). As described further below, the systems of the present invention will preferably have access to a database, which contains a large volume of different words that are correlated (within such database) with an indication as to whether such word is predominantly used as a verb, noun, adjective, adverb, or other type of speech component.

According to yet further embodiments, the algorithms and systems used in the present invention will further be configured to test the presence of words and word sequences from custom stop word lists and custom keyword lists in the input files. The algorithm computes a score when matches occur, which is referred to herein as “(e)”. According to such embodiments, the matches in stop word lists will have a negative score, while matches in custom keyword lists have a high positive score, reflecting the desire to excuse or promote the content from those lists. The calculated (e) value for each word set can also be assigned to each word included within each set of words, for the purpose of calculating the total score for each word as described below.

The invention provides that the foregoing scores, (a), (b), (c), (d), and (e) may be combined with other scores and metrics that may be calculated from corresponding audio content, such as scores that are correlated to intensity or loudness; confidence level in transcription, understanding, and clarity of each word; speed of speech; and/or even location within a speech. The invention provides that such combinations may use any functional approach desired, such as addition, multiplication, convolution, etc. The invention provides that by incorporating a measure of clarity and confidence level, the algorithm will be rendered highly robust to noise, just as human understanding of speech is highly robust to noise.

After the algorithm has completed its analysis for each word, the invention will preferably calculate a total score for each such word, based on the foregoing scores that will include (a), (b), (c), (d), and (e). In addition, the invention provides that each score may optionally be weighted, such that certain of these metrics are given more relevance than others, e.g., total score=x₁(a)+x₂(b)+x₃(c)+x₄(d)+x₅(e), wherein each of x₁-x₄ represent a weighted value (such that the scores for (a), (b), (c), (d), and (e) are adjusted to reflect each assigned weighting factor).

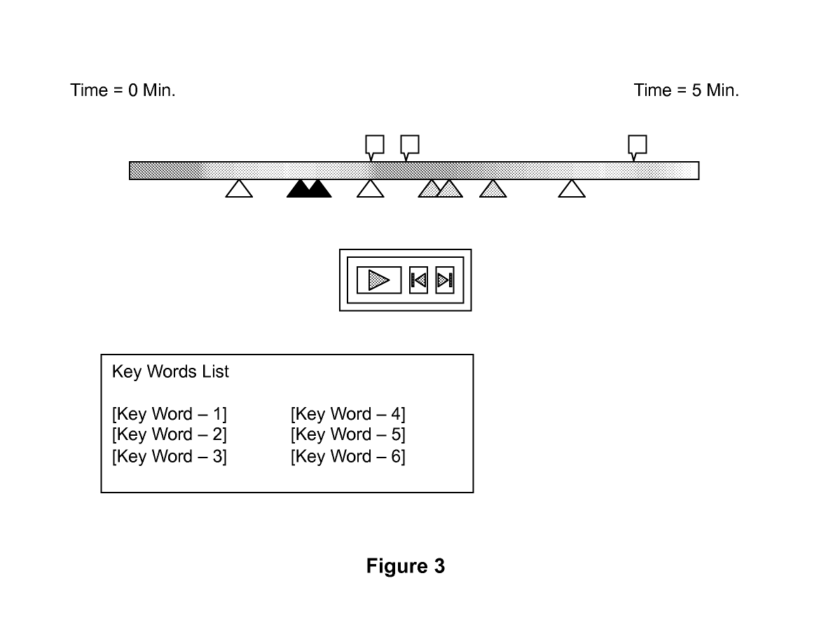

After the total score is calculated for each word, the system may generate a type of “heat map,” which expresses the relative importance of the words used within the content, in an aggregated fashion from the beginning of an input file to its end. More particularly, as illustrated in FIG. 3, the invention provides that an input file, or portion thereof, may be graphically represented in such a manner that identifies those portions of the content (sequential words) that have relatively higher total scores (and those that have relatively lower total scores). In the example shown in FIG. 3, areas of the heat map that exhibit a darker color will be correlated with words having relatively higher total scores, whereas areas of the heat map that exhibit a lighter color will be correlated with relatively lower total scores. Such graphical (and/or numerical) representations allow users of the system to quickly identify those portions of a particular input file that are more relevant and substantive (and those which are less relevant).

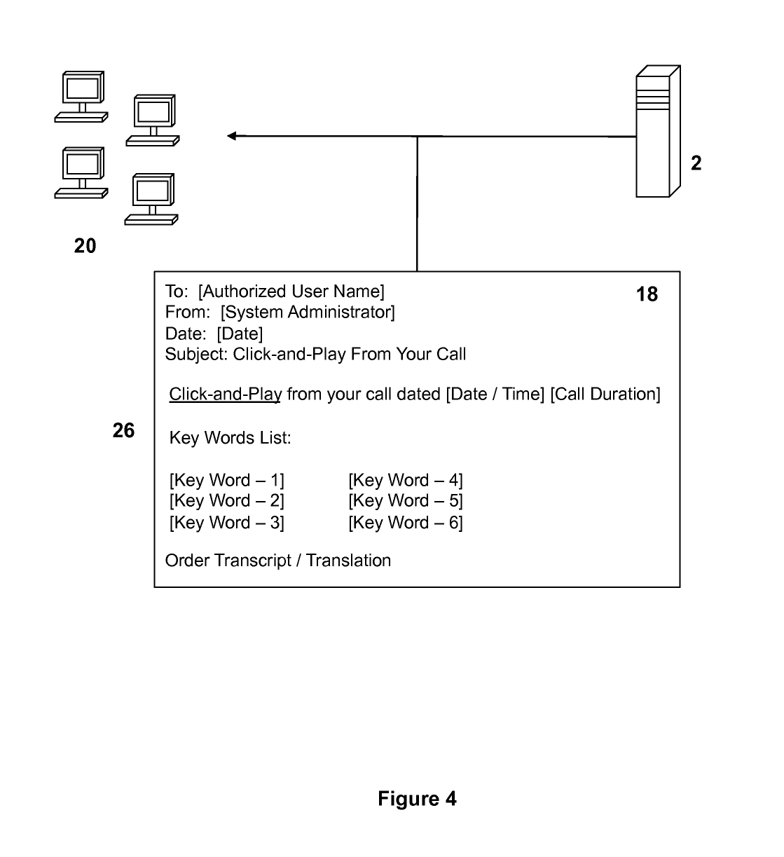

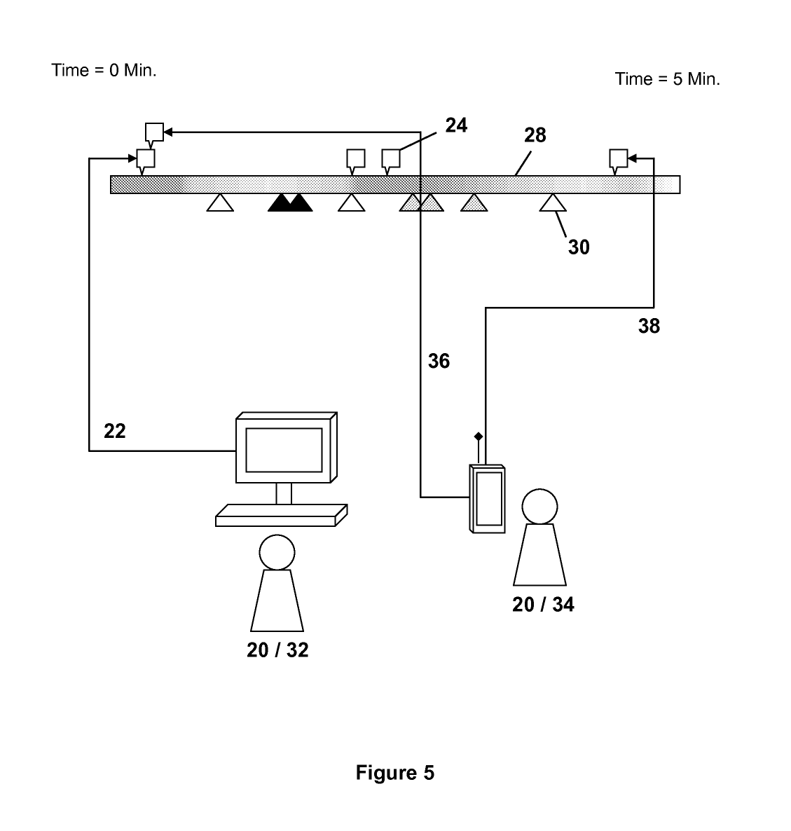

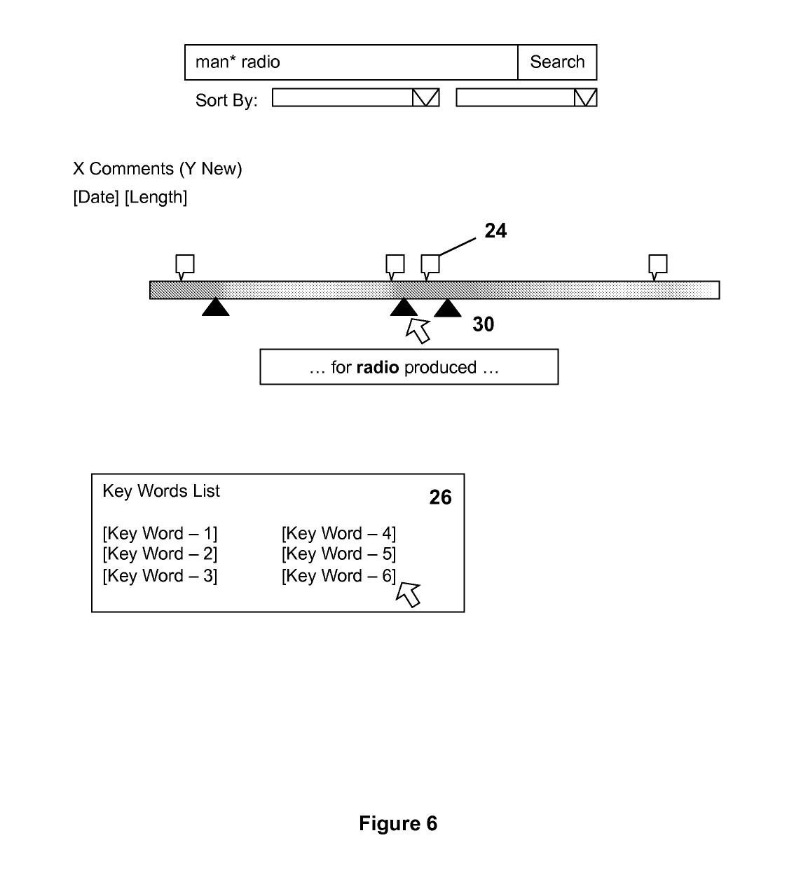

In addition, and referring now to FIG. 4, the invention provides that rapid access to the graphical representation of the input file content is enabled through emails 18 to a defined number of users 20, who are authorized to access the input file. As explained further below, and illustrated in FIG. 5, the invention provides that the systems will enable such users to publish commentary to the graphical representation of a particular input file through the email 18 interface. Responses 22 to the emails 18 from the authorized users 20 cause a comment 24 to be inserted in the graphical representation of the input file at the appropriate time point. A list 26 of the top concepts or keywords from the file are displayed in the emails 18 (FIG. 4), and the graphical representation of the file (FIG. 6). As illustrated in FIG. 6, user selection of any of the keywords in the list 26 will cause the display of markers 30 showing the relative position of the keywords in the graphical representation of the file, snippets of text surrounding the keywords, and enabling playback of the content at that position for video and audio files, as illustrated in FIG. 6.

The invention provides that the means by which words are analyzed, as described above, may be carried out by the systems in an efficient and expedient manner. Indeed, the invention provides that the total scores can actually be calculated following a single read, from beginning-to-end, of the analyzed content. In addition, the invention provides that the system may be configured to calculate these total scores, and generate relevancy/heat maps, based on discrete portions of an input file (e.g., discrete portions of a particular speech). In certain cases, such portions may pertain to, for example, (i) only the words that are communicated by a particular speaker, (ii) only the words that are confined within a particular segment of a speech, (iii) only the words that satisfy a defined intensity threshold, or other factors.

According to still further embodiments, the invention provides that multiple speeches can be scored together. When the system analyzes audio content in the manner described from a set of search results (as described further below), the system will be configured to assign greater relevance to content that is located near the beginning of a set of search results, relative to content that is analyzed near the end of a set of search results. This way, the system further accounts for the results generated by a third party search and ranking algorithm, e.g., the search and ranking algorithms that are utilized by Internet search engines or the input file search engines referenced below.

The invention further provides an on-line structure for total score management, which allows a user to call back total scores that were calculated for content that was analyzed in the past. According to such embodiments, these score retrieval functionalities may be utilized for subsequent partitioning of speech content that was generated by a particular speaker, within a specified portion of speech, or within other parameters. In addition, scores can be juxtaposed with scores from other input files (e.g., speeches) to rapidly generate combined scores for a particular speaker.

System Architectures and Implementation Platforms

The invention provides that the above-described methods for analyzing words included within text, audio, and video content and, particularly, to extracting and communicating important themes, concepts, topics, and keywords found within such content may be implemented in a variety of different environments and platforms, as described further below.

Content Archival and Analysis Environment

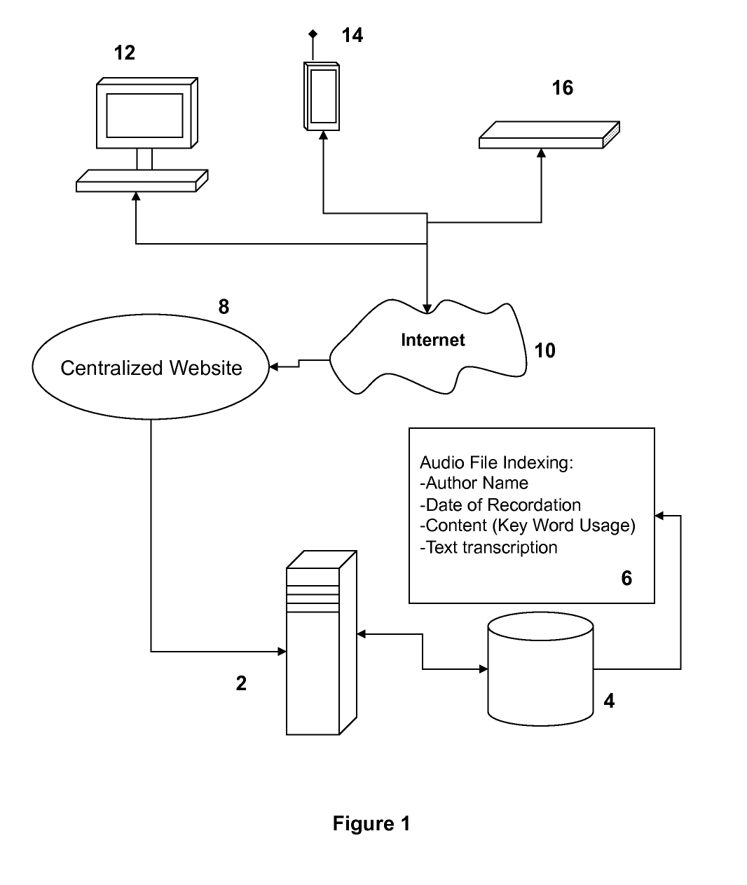

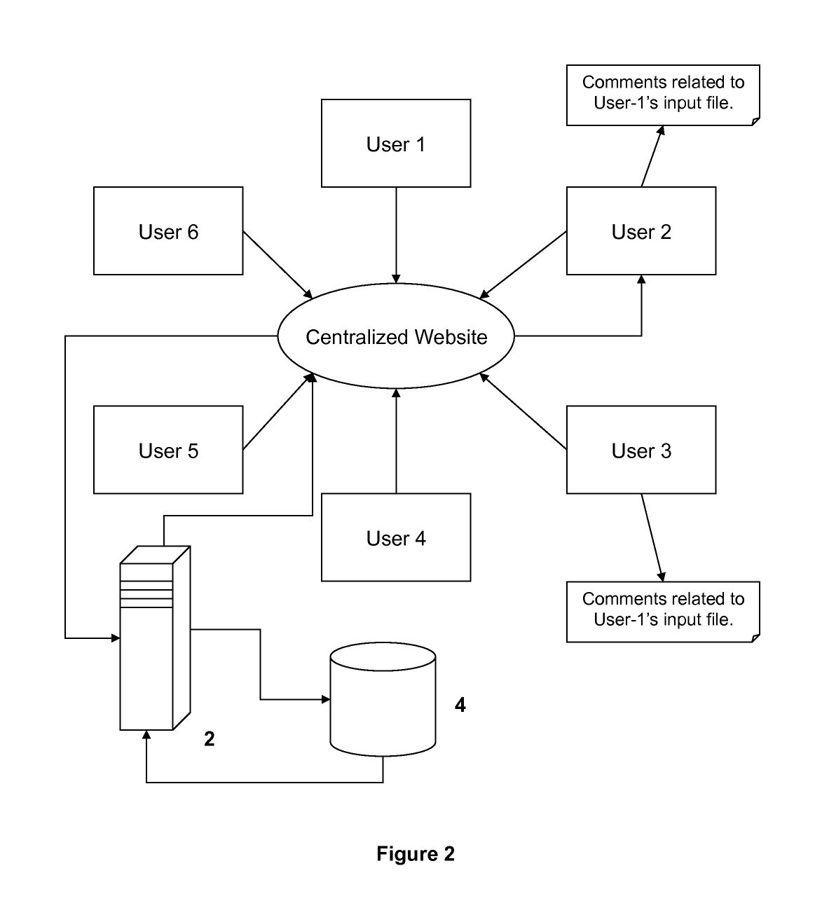

Referring now to FIGS. 1 and 2, according to certain preferred embodiments, the above-described methodology (and algorithms), which are also referred to herein as the “content recognition and analytics engine,” may be utilized with a system that is configured for recording, indexing, transcribing, and sharing input files among a plurality of users. As used herein, the term “input file(s)” refers to text files, digital audio content, video files, voice recordings, streamed media content, and combinations of the foregoing. Referring to FIG. 1, the systems generally comprise a server 2 that is configured to receive, index, and store a plurality of input files, which are received by the server 2 from a plurality of sources, within at least one database 4 in communication with the server 2. The invention provides that the database 4 may reside within the server 2 or, alternatively, may exist outside of the server 4 while being in communication therewith via a network connection.

When the present specification refers to the server 2, the invention provides that the server 2 may comprise a single server or a group of servers. In addition, the invention provides that the system may employ the use of cloud computing, whereby the server paradigm that is utilized to support the system of the present invention is scalable and may involve the use of different servers (and a variable number of servers) at any given time, depending on the number of individuals who are utilizing the system at different time points, which are in fluid communication with the database 4 described herein.

The input files may be indexed 6 and categorized within the database 4 based on author, time of recording, time of uploading, geographical location of origin, IP addresses, language, keyword usage, combinations of the foregoing, and other factors. The invention provides that the input files are preferably submitted to the server 2 through a centralized website 8 that may be accessed through a standard Internet connection 10. The invention provides that the website 8 may be accessed, and the input files submitted to the server 2, using any device that is capable of establishing an Internet connection 10, such as using a personal computer 12 (including tablet computers), telephone 14 (including smart phones, PDAs, and other similar devices), meeting conference speaker phones 16, and other devices. The invention provides that the input files may be created by such devices and then uploaded to the server 2 or, alternatively, the input files may be streamed in real time (through such devices) with the input files being created (and then indexed and stored) within the server 2 and database 4. In addition, as explained above, the invention provides that the input files that are stored within the server 2 and database 4 may be derived from text files, audio-only content (e.g., a telephone conversation or talk radio) or, in certain cases, may comprise audio tracks derived from a video file (which has an audio component embedded therein).

The invention provides that the server 2 may receive and manage input files in many ways, such that the contents thereof may be deciphered and used as described herein. For example, as mentioned above, the invention provides that upon an input file being submitted to the server 2, which is formatted as an audio or video file, the server 2 will perform a speech-to-text, speech-to-phoneme, speech-to-syllable, and/or speech-to-subword conversion, and then store an output of such conversion within the database 4. This way, the contents of such input files may be intelligently queried, analyzed as described above, and used in the manner described herein.

The invention provides that when reference is made to “input files that contain a keyword,” and similar phrases, it should be understood that such phrase encompasses a text file that contains the keyword, with the text file being derived from an input file, as explained above. As such, after performing a speech-to-text conversion for audio/video files, and storing such text within the database 4, a search may be performed using the system of the present invention for input files that contain a particular keyword, whereupon the system will actually search the text of such input files. Upon identifying any text forms of such input files that contain the queried keyword, it will be inferred that the input file that corresponds with the searched text file will actually contain the keyword. In addition, each input file that is represented within the search results may be analyzed using the content recognition and analytics engine described above (or previous analyses conducted by the content recognition and analytics engine may be called back and associated with each respective input file).

Referring now to FIG. 2, according to certain preferred embodiments, the invention provides that the server 2 is configured to make one or more of the input files accessible to persons other than the original source (or author) of the input files. The invention provides that the term “source” refers to a person who is responsible for uploading an input file to the server 2, whereas the term “author” refers to one or more persons who contributed content to an uploaded input file (who may, or may not, be the same person who uploads the input file to the server 2). For example, as illustrated in FIG. 1, a first user (User-1) may submit an input file to the server 2 through the centralized website 8, which is then indexed and stored within a database 4. The invention provides that if certain conditions are satisfied, the input files that the first user (User-1) records within and uploads to the database 4 will then be accessible by other persons. For example, a second user (User-2) may retrieve and review User-1's input file from the database 4 through the centralized website 8. Upon retrieving and accessing User-1's input file, User-2 may publish comments regarding User-1's input files within a graphical user interface of the website 8. Alternatively, as described further below, User-2 may publish comments regarding User-1's input files via email interactions with the server 2.

These systems may further allow users to query the database 4 for input files that may be of interest or otherwise satisfy search criteria. The server 2 may then present the search results to the user within the website 8 and, preferably, list all responsive input files in a defined order within such graphical user interface, but only those input files to which the user has been granted access. For example, the search results may list the input files in chronological order based on the date (and time) that each input file was recorded and provided to the database 4. In other embodiments, the input files may be listed in an order that is based on the number of occasions that a keyword is used within each input file. Still further, the input files may be listed based on the number of occurrences of keywords in metadata associated with the input files, such as titles, description, comments, etc. In addition, the input files may be listed by measuring user activity, such as the number of views or plays, length of playing time, number of shares and comments, length of comments, etc. These criteria, combinations thereof, or other criteria may be employed to list the responsive input files in a manner that will be most relevant to the user. Still further, the invention provides that a user may specify the criteria that should be used to rank (and sort) the search results, with such criteria preferably being selected from a predefined list.

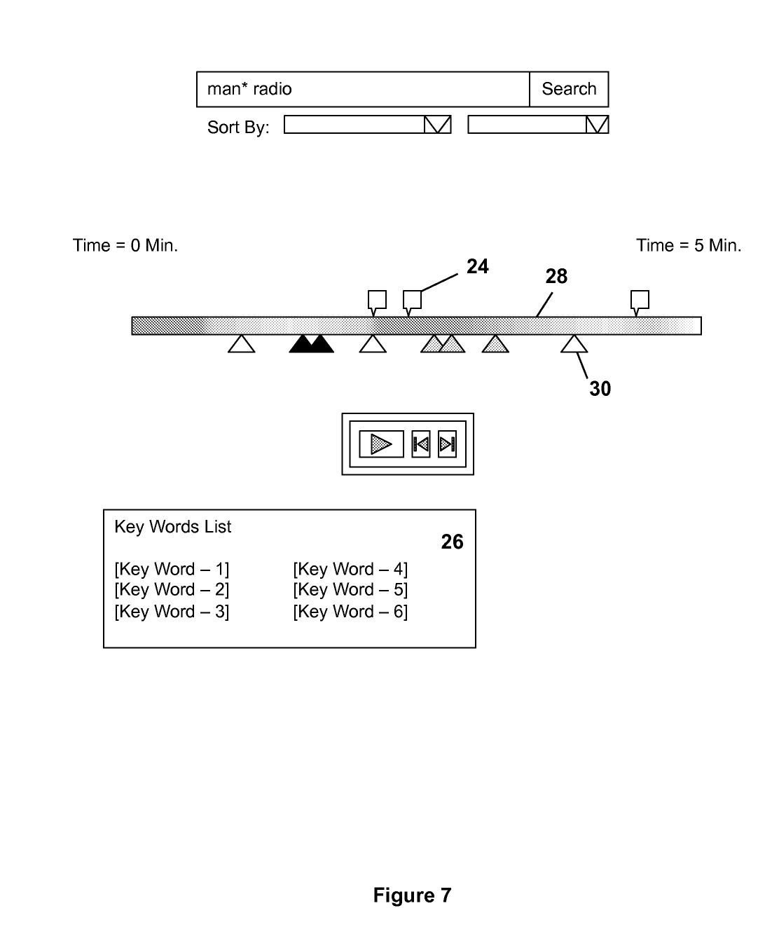

As explained above, each input file included within a set of search results will preferably be graphically portrayed, such as in the form of a timeline 28 (FIG. 5) that begins at time equals zero (t=0) and ends at a point when the input file is terminated. For example, if the total length of an input file is five minutes, the left side of the line will be correlated with t=0 of the input file, whereas the right side of the line will be correlated with t=5 minutes of the input file. Still further, the invention provides that the location of each search term that was queried may be indicated along the timeline 28. For example, and referring to FIG. 7, the location of each search term may be indicated with a triangle 30, or other suitable and readily visible element. The invention further provides that if multiple search terms were used in the search, the timeline 28 may be annotated with multiple triangles 30 (or other suitable elements), each of which may exhibit a different color that is correlated with a particular search term. More particularly, for example, if two search terms are used, the timeline 28 may be annotated with triangles 30 (or other suitable elements), which exhibit one of two colors, with one color representing a location of a first search term (keyword) and a second color indicating the location of a second search term (keyword), as illustrated in FIG. 7. The invention further provides that each timeline 28 that represents a relevant input file may be annotated with one or more comments 24 posted by other users, as described herein. The invention provides that such annotation with comments 24 will preferably indicate the location within the input file to which each comment 24 relates.

As described above, the invention provides that these input files may be analyzed using the content recognition and analytics engine described herein. This way, and referring to FIG. 7, the graphical representation (each timeline 28) that represents a relevant input file may not only be annotated with one or more comments 24 posted by other users, as described herein, but it may also exhibit a type of “heat map” coloration. According to such embodiments, as described above, the variable colored timeline 28 will indicate portions of the input file that exhibit a higher total score calculated by the content recognition and analytics engine described herein (indicated with a darker color in FIG. 7), as well as portions of the input file that exhibit a lower total score (indicated with a lighter color in FIG. 7).

Telecommunications Environment

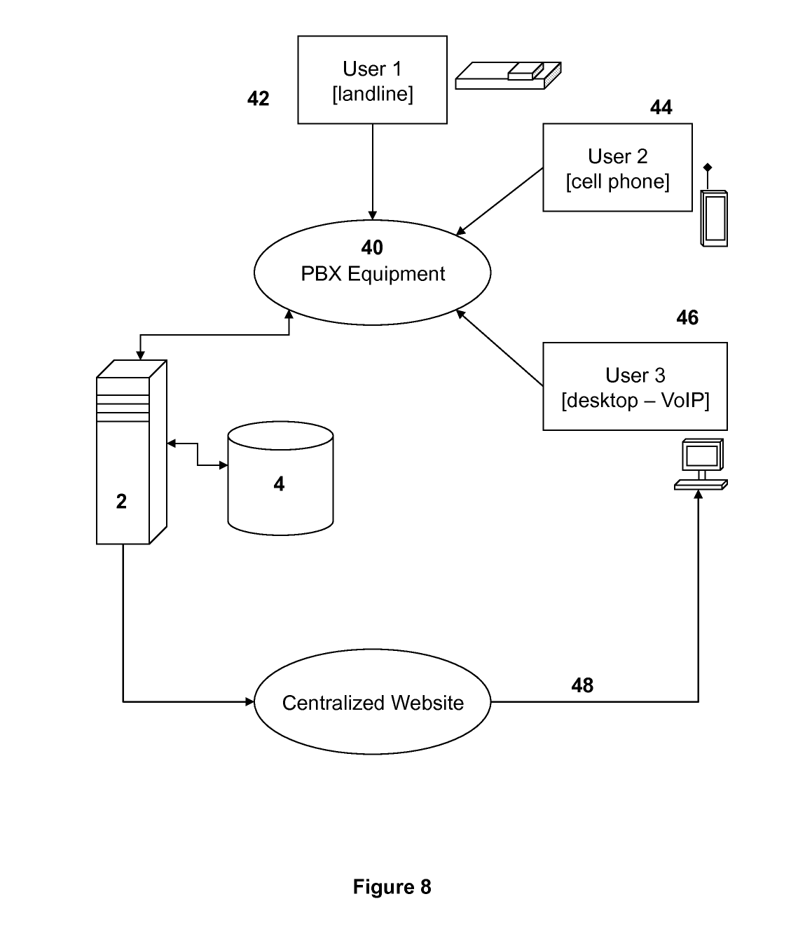

According to additional embodiments of the present invention, the above-described methods can be incorporated into a telecommunications, VOIP, and/or Asterisk PBX environments. In such embodiments, and referring to FIG. 8, the above-described content recognition and analytics engine is incorporated into certain centralized PBX equipment (PBX exchange) 40, with the algorithms and exchange being configured to identify key concepts from every call participant (regardless of how each participant connects to the PBX equipment, e.g., landline 42, cell phone 44, desktop (VoIP) 46, etc.). More particularly, for example, speakers of content that is analyzed using the content recognition and analytics engine may be connected via their communication equipment 42,44,46 to a central PBX exchange 40. Each caller's audio content is routed through the PBX exchange 40 and the server 2 (which may be present in the speaker's facility), where the audio content is then analyzed using the content recognition and analytics engine described above. The invention provides that the results of such analysis may then be issued 48 to certain authorized users (e.g., via the email distribution embodiment described above).

The invention provides that the content recognition and analytics engine may be configured to connect to each call, at the time each call is initiated, and proceed to generate a transient analysis of the spoken content in the call. The content recognition and analytics engine may be configured such that the top scoring parts of a particular call (i.e., the input file that is generated from the call) are organized into a list that is time synchronized to the call contents (if the call is recorded). The invention provides that call participants may receive a list of key terms that were spoken during the call (e.g., words, or groups of words, which exhibit the highest total scores), as computed by the content recognition and analytics engine. The call participants may then review any part of the call—again, if the audio content of the call was recorded. If the call was not recorded, the list of key terms identified by the content recognition and analytics engine may still be useful, insofar as it would provide a good written summary of the topics discussed during the call. The provision of the system's analysis in this environment may be executed through the delivery of emails, as explained above.

Live Conference Environment

In addition, the invention provides that the content recognition and analytics engine may be utilized during a virtual event or live conference service. In such embodiments, the content recognition and analytics engine may be used to provide instant highlights of the presentations that are delivered during a live event. In the case of a conference environment, the content recognition and analytics engine may be employed to organize a set of speeches thematically, chronologically, by speaker, or according to other criteria.

Email Commentary Functions

As described above, the system may be configured to deliver certain analyses generated by the content recognition and analytics engine via email to one or more users. More particularly, the content recognition and analytics engine may be configured to deliver summaries and analyses of the content that it analyzes using the methods described herein. For example, the system may be provided with one or more email addresses to which certain content pertains, such that the content recognition and analytics engine may then deliver its analyses of content to such email addresses 18 (FIG. 4). The email 18 may include (or contain links to) textual summaries of the analyzed content, a listing of keywords 26 detected within the analyzed content, graphic representations of timelines 28 and content “heat maps” as described above (or links to such graphic representations), hyperlinks within such graphic representations that allow a viewer to “click” in certain areas to load the desired portions of the analyzed audio content, or combinations of the foregoing. For example, upon “clicking” a certain part of the graphic timeline, the system will be instructed to begin playing the audio content that is correlated to such location on the timeline 28.

Referring to FIG. 5, the invention provides that the system may further allow viewers of such emails to publish comments regarding the audio content, and interact with the system via email. For example, the individual 32 who originally uploaded content to the system may respond/reply 22 to the system's initial email, and include comments 24 within his/her email that may then be published in connection with the content (and available for viewing by others). The invention provides that such comments may be correlated with discrete locations on the timeline 28 for a particular input file, thereby enabling the user to publish a comment regarding a particular portion of the input file. In addition, the system may enable other users 34 to edit or supplement 36 previously-published commentary. For example, comments that are preceded with a plus (+) symbol (and a timeline 28 position number) will be added to the input file, whereas comments that are preceded with a minus (−) symbol (and a timeline 28 position number) will be deleted from the input file. The invention may also be configured to allow users to move comments from one part of the timeline for an input file to another location. As mentioned above, the invention provides that other users of the system 34—who did not originally upload a particular input file to the system—may be permitted to respond to commentary posted by others (or even post their own commentary to the timeline 38). According to such embodiments, the comments posted to a timeline and affiliated with a particular input file are preferably coded to disclose the author of the comment (and the time of publication). In addition to textual commentary, the invention provides that other metadata may be published to a particular timeline and affiliated with an input file, e.g., exclamation points, colored labels, or other insignia that will have a pre-defined meaning to the users of the system.

Advertising Engine

According to yet further embodiments of the present invention, the input files provided to the server and database by each user may be automatically queried for certain keywords included therein, using the content recognition and analytics engine. More particularly, the system may query each input file to determine whether any words included therein are found in a pre-recorded list of advertising terms. If such analysis reveals that any of the words included within the input files match any of the pre-recorded advertising terms, the server may cause a relevant advertisement to be posted within the graphical user interface of the website 8 described above, or an email that is delivered to a user as described above. Referring to the example above, if a user uploads an input file to the database which includes (in the transcript of the audio content thereof) the word “golf,” the server may published one or more golf-related advertisements in the graphical user interface of the website (or within an email summary). According to such embodiments, the invention provides that the server will be in communication with one or more databases that correlate certain terms with one or more advertisements.

In addition, the invention provides that whether certain advertisements are posted within the website (or email summary) may be determined not only on whether a particular input file includes a certain keyword, but also the number of times that such keyword is used within an input file. For example, if the system detects that a particular user has submitted a certain minimum number of input files to the database which include the word “golf” (and not just a single input file that contains such term), the server may cause one or more advertisements related to golf products or golf services to be published in the website (or email summaries).

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for identifying, summarizing, and communicating topics and keywords included within spoken content, which comprises a server that is configured to:
(a) receive one or more input files containing spoken content from an external source;
(b) process the input files using speech-to-text transcription when the spoken content is formatted as a video or audio file; and
(c) apply an algorithm to the transcribed text in order to analyze the spoken content, wherein the algorithm calculates a total score for each word included within the transcribed text, wherein the total score is calculated using a plurality of metrics which comprise:
(i) a length of each word in relation to a mean length of words;
(ii) frequency of letter groups used within each word;
(iii) frequency of repetition of each word and word sequences;
(iv) a part of speech that is represented by each word; and
(v) membership of each word within a custom set of words.

2. The system of claim 1, wherein the system calculates a sub-score for each of the plurality of metrics, whereupon the total score is calculated as a sum of the sub-scores.

3. The system of claim 1, wherein each of the plurality of metrics may be:
(a) multiplied by a weighting factor;
(b) adjusted based on metadata contained within the input files, wherein said metadata are selected from a group consisting of intensity, loudness metrics, confidence level in transcription, clarity of word, speed of speech, location within a speech, and combinations of the foregoing; or
(c) a combination of (a) and (b).

4. The system of claim 3, wherein the server is further configured to generate a graphical user interface that portrays a beginning and an end of each input file or excerpt thereof.

5. The system of claim 4, wherein the graphical user interface that portrays a beginning and an end of each input file visually identifies and labels segments of the input file that are correlated with a higher or lower total score that is calculated by the algorithm.

6. The system of claim 5, wherein the server is operably connected to a centralized website within which a plurality of users may access, view, and publish comments to the graphical user interface that portrays a beginning and an end of each input file.

7. The system of claim 5, wherein the server is operably connected to, or in communication with, a telecommunications, VOIP, or Asterisk PBX system.

8. The system of claim 5, wherein the server is configured to email a defined number of users a message, which allows recipients of said email to access, view, and publish comments to a graphical user interface that portrays a beginning and an end of each input file.

9. The system of claim 8, wherein the defined number of users may add or delete comments, and publish such comments to the graphical user interface, through an email interface by including commands within a reply message to said email, wherein said commands specify (i) whether a comment is being added or deleted and (ii) a numeric position within the graphical user interface where the comment should be added or deleted.

10. The system of claim 9, wherein the defined number of users may add commentary to the comments published by other users through the email interface.
